(19) United States
(12) Patent Application Publication
(10) Pub. No.: US 2007/0006294 A1
(43) Pub. Date: Jan. 4, 2007

(54) Secure flow control for a data flow in a computer and data flow in a computer network

(76) Inventor: G. Kenneth Hunter, Severn, MD (US)

Correspondence Address: RADER FISHMAN & GRAUER PLLC, LION BUILDING, 1233 20TH STREET N.W., SUITE 501, WASHINGTON, DC, 20036, US

(21) Appl. No.: 11/169,644

(22) Filed: Jun. 30, 2005

(51) Int. Cl. H04L 9/00; G06F 15/16

(52) U.S. Cl. 726/14; 726/1

(57) ABSTRACT

Systems and methods of the present invention manage data flow of a computer and computer network in a secure domain. The system includes an administration module and a management module. The administration module assigns a security label to data within the secure domain, and establishes a set of schema based on the security labels associated with the data. The management module regulates data flow within the secure domain based on the set of schema.

### TECHNICAL FIELD OF THE INVENTION

This invention relates generally to control data flow in a communication device or data flow over a network having a plurality of communication devices, and more particularly to protection and assurance of data and multilevel classification and storage of data in a communication device and on a network.

### BACKGROUND OF THE INVENTION

The electronic exchange of information to conduct business is fast becoming a necessity for businesses, governments, and consumers. Information has been proven to have economic value through its possession, organization, or access. As a result, the protection of information is essential to the owner in maintaining the value of that information. Despite the cost and effort used to protect information from unauthorized access, attacks on computer systems continue to increase. These attacks include, among others, hacking, communicating viruses, denial of service attacks, and communicating unwanted email (SPAM). These activities compromise system security by altering data, intercepting data, and/or hiding authorship and location. Moreover, computer attacks hinder the operation of a computer or worse prevent the proper communication of data over a network. Computer attacks continue because of the inherent vulnerabilities inherent of computers and the manner in which the industry responds when these vulnerabilities are exploited.

Vulnerabilities are entry points into a computer and are means in which programmers can hook into the operating system. While these vulnerabilities, for the most part, do not harm the computer, they can and frequently are used to attack and harm a computer system. One common aspect of all vulnerabilities is their dependence on portions of the memory space of the particular computer, which are individually specific.

All memory in a computer is grouped into memory locations of manageable sized blocks called pages. As needed, the central processing unit (CPU) of the computer allocates and deallocates pages, at a rate of a page at a time (larger allocations involve multiple page allocations). As a security measure, some operating systems completely zero allocated pages prior to use so that data from another process does not remain in that memory location. Access to those pages is made via virtual memory references instead of physical memory references. The virtual memory reference must be translated into an actual physical address before the CPU can perform the requested operation. Moreover, this physical address may be located in Random Access Memory (RAM) or in a page file on a disk, which requires that the page file be fetched from the disk and stored in the RAM before it can be accessed.

In functional operating systems (including multi-threaded environments), memory is further divided into two portions based on the kernel of the operating system or based on user action through a software application. Each process that operates on a system is given its own private virtual memory space. When a process is activated, the process runs in “user mode” on the CPU. Every thread in the process can access all the memory allocated to that process. However, because each process maintains its own page table of user memory, no thread in the process may access memory outside of that process, which is maintained by another process. Thus, because memory is allocated into pages and each process maintains its own page table of user memory, conventional systems provide the capability to reuse objects.

The kernel portion of the memory is reserved for the operating system, which has its own memory space. However, because there is only one operating system running on a computer, the kernel is allocated only one kernel memory space. The CPU only accesses the kernel memory when it is in “kernel mode” and the operating system is the only element on the computer system that can operate in the kernel mode. Thus, user processes cannot directly access the operating system memory while operating in the user mode. When a user process makes a call to a service of the operating system, however, that process is typically switched into kernel mode. Once in kernel mode, the operating system performs its function, returns to the user mode, and then returns to the user code. However, while in kernel mode, the user process has full access to all of the kernel memory space. In addition, because all of the page table's pointers are held in kernel memory, with a little manipulation, the process can access any user process' memory. Therefore, although it is necessary to have the operating system in a global address space so that it can be integrated with all the running user processes, the location of the operating system creates a vulnerability through which address separation can be violated.

Memory can also be shared between two processes explicitly through a feature called “memory mapped files.” These “memory mapped files” are not actually files, but are blocks of memory that have been designed to be accessible to multiple processes. The danger of using “memory mapped files” stems from the fact that there is no mechanism to check the integrity of the data or to ensure that both processes are authorized to access that block of memory. For example, although access to shared memory can be limited to authorized subscribers in the user mode, this security check may be easily circumvented via the kernel mode.

Moreover, some processors contain a number of instructions that may perform restricted operations in the user mode. Unchecked these instructions may be used to either modify the privilege level of the processor or directly access memory circuitously. As a result, computer systems enable a user process to operate in kernel mode without being part of the operating system, or move data in memory across partitioned memory blocks even while in user mode.

Software applications may sometimes execute rogue operations or contain undefined features. In particular, a software application may perform many unpredictable actions. Generally, computer system architecture is based on an assumption that software applications will follow and not deviate from the published interface. However, when the software application performs a rogue or unpredicted operation, not only are unpredictable results obtained but system security and stability are affected as well.

By gaining access to the memory space vulnerabilities are leveraged to achieve the right conditions for malicious activity to exist. For example, a hacker may gain access to specific segments of memory and execute instructions through the CPU. By executing instructions using the CPU, a hacker can control the flow of data by creating a new data flow, prepending information to an existing data flow, or appending information to an existing data flow.

As discussed above, making systems secure from attacks is now a top business priority as the annual monetary and intellectual property losses mount due to inherent vulnerabilities in systems and networks. However, the common industry response to vulnerabilities is reactive. Today, the security industry focuses on “patching” known vulnerabilities individually. The industry reacts only when a vulnerability is exposed, which is typically through an attack or through research efforts geared towards finding vulnerabilities. Because computers and networks are complex, a massive number of vulnerabilities exist even after a patch is installed. The huge number of operational layers and components of computers and networks create a vast matrix of interactions and side effects such that the complexities go well beyond the capacity of the industry to manage or fully identify. Thus, computers and networks are inherently insecure and always susceptible to both known and unknown vulnerabilities.

Therefore, the need exists for methods and systems capable of protecting a computer system and network environment from all security attacks whether the mode of attack is known or unknown, and stabilizing the computer and network through secure memory management.

### BRIEF SUMMARY OF THE INVENTION

To overcome the above problems and other disadvantages of the prior art, methods and systems are provided for controlling data flow in a computer and on a computer network.

In order to remedy the vulnerabilities related to memory access the present invention augments the memory manager of the conventional computer system to provide a security scheme that is non-circumventable. The systems and methods of the present invention attach a label to all data stored on the network. The secure memory management scheme maintains the multi-threaded capabilities of the conventional memory space by dividing the memory into a kernel space and user space. However, in order to stabilize the system and eliminate the vulnerability introduced with object reuse, the kernel and user memory spaces are further divided based on division, subdivision, and restriction boundaries. In this manner, the security label attaches the data contained in the memory, controls access to the memory, as opposed to the CPU privilege level as used in conventional systems.

In an embodiment of the invention, a method of managing data flow on a computer comprises the steps of establishing a secure domain on the computer; assigning a security label to data within the secure domain; establishing a set of schema based on the security labels associated with the data; and regulating data flow within the secure domain based on the set of schema.

In another embodiment of the invention, a method of managing data flow between a plurality of communication devices on a network, the method comprises the steps of, in a first device of the plurality of communication devices, establishing a secure domain on the network; assigning a security label to data within the secure domain; establishing a set of schema based on the security label of the data; and regulating data flow within the secure domain based on the schema.

In another embodiment of the invention, a method of managing data flow between a plurality of communication devices in a network having a secure domain, the method comprises, in a first device of the plurality of communication devices, receiving a data flow from a second device of the plurality of communication devices on the network; determining whether the received data conforms to a set of schema associated with the secure domain; and processing the received data flow when the data conforms to the set of schema.

In another embodiment of the invention, a method of managing data flow between a plurality of communication devices in a network having a secure domain, the method comprising, in a first device of the plurality of communication devices, receiving a data flow from a second device of the plurality of communication devices on the network; determining whether the received data flow conforms to a set of schema associated with the secure domain; and displaying a known published message when the received data flow fails to conform to the set of schema.

In another embodiment of the invention, a communication device that controls data flows on a network having a secure domain, the communication device comprises an administration module that provides a graphical user interface to designate a set of schema to correspond to data flow within the secure domain; and a management module that determines whether data flows conform to the set of schema.

In another embodiment of the invention, a method of establishing a data flow of data on a communication device in a secure domain, the method comprising the steps of comparing a context of the data to a source of the data; determining whether a direction of the data flow, when the data context does not match the data source; determining whether a transitive flow is authorized with the data, when the direction of the data flow is within a first information boundary; determining whether a user is authorized to execute the data flow, when the transitive flow is authorized; and establishing the data flow when the user is authorized to execute the data flow.

The description of the invention and the following description for carrying out the best mode of the invention should not restrict the scope of the claimed invention. Both provide examples and explanations to enable others to practice the invention. The accompanying drawings, which form part of the description for carrying out the best mode of the invention, show several embodiments of the invention, and together with the description, explain the principles of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

Additional embodiments and modifications to the above are within the scope of the present invention and will be described and more fully understood upon reading the following detailed description in conjunction with the accompanying drawings.

### BRIEF DESCRIPTION OF DRAWINGS

In the drawings:

FIG. 1 is a block diagram illustrating a communication network in accordance with an embodiment of the present invention;

FIG. 2 is a block diagram illustrating a common logical computer infrastructure in accordance with the prior art;

FIG. 3a is a block diagram illustrating a secure logical infrastructure in accordance with the prior art;

FIG. 3b is a block diagram illustrating a secure logical infrastructure in accordance with an embodiment of the present invention;

FIG. 4 is a block diagram illustrating an operational model in accordance with an embodiment of the present invention;

FIG. 5 is a block diagram illustrating components of a security domain in accordance with an embodiment of the present invention;

FIG. 6 is a block diagram illustrating a data format in accordance with an embodiment of the present invention;

FIG. 7 is a block diagram illustrating an information boundary in accordance with an embodiment of the present invention;

FIG. 8 is a block diagram illustrating a memory configuration in accordance with an embodiment of the present invention;

FIG. 9 is a block diagram illustrating an enforcer in accordance with an embodiment of the present invention;

FIG. 10 is a block diagram illustrating a class driver filter in accordance with an embodiment of the present invention;

FIG. 11a is a flow diagram illustrating a memory management process in accordance with the prior art;

FIG. 11b is a flow diagram illustrating a memory management process in accordance with an embodiment of the present invention;

FIG. 12 is a flow diagram illustrating a health and status check process in accordance with an embodiment of the present invention;

FIG. 13 is a block diagram illustrating a security model in accordance with an embodiment of the present invention; and

FIG. 14 is a flow diagram illustrating a process of establishing a data low in accordance with an embodiment of the present invention.

### DETAILED DESCRIPTION

Reference will now be made in detail to an implementation of the invention, an example of which is illustrated in the accompanying drawings. Wherever possible, the same reference numbers will be used throughout the drawings to refer to the same or like parts.

Generally, flow control is a function that prevents network congestion by ensuring that transmitting devices do not overwhelm receiving devices with data. A high-speed computer, for example, may generate traffic faster than the network can transfer it or faster than the destination device can receive and process it. However, flow control in the context of the present invention refers not to the prevention of network congestion but the prevention of unauthorized or malicious access to data flows on a computer or data flows within a network. These data flows include operating system programs and related calls, application programs and related calls, object and resource calls, all files, and the like. The central processing unit (CPU) of a computer system processes data as either intra-processor information or computer-to-computer information. The systems and methods of the present invention control the security context of the source and destination for each piece of data through object-oriented coding. All data within an established secure domain of the computer or network, is tagged with a security label. Schema rules are labeled or tagged onto each piece of data and protect the tagged data within a secure domain established in the computer or on the network. This security label is forever attached to the data and allows the data to be controlled wherever it is located within the secure domain.

Computer networks may come in a variety of different shapes and sizes. For example, Local Area Networks (LANs) enable multiple users in a relatively small geographical area to exchange files and messages, as well as access-shared resources such as file servers and printers. A networked office building, school, or home may contain a single LAN. On the other hand, one building may contain a few small LANs, and occasionally a LAN will span a group of buildings. Wide Area Networks (WANs) generally interconnect a geographically dispersed collection of LANs to establish network connectivity. The Internet is an example of a WAN that interconnects LANs spanned over most of the world. Every LAN and WAN include computers or devices that function as servers and clients. Each server and client device is configured with hardware and software components that enable it to successfully communicate with other devices on the network. To achieve secure flow control, the present invention modifies the configuration a computer and particularly, the configuration of each server and client on the network by integrating specialized software components into their respective infrastructures. For example, a client software component is integrated into every client connected to the network and a server software component is integrated into both primary and backup servers connected to the network. The specialized software components of the server and client include a set of modules that leverage existing published Application Programming Interfaces (API) for all operating systems. Moreover, these modules implement a new contextual memory realization (CMR) to address the impediment of object reuse.

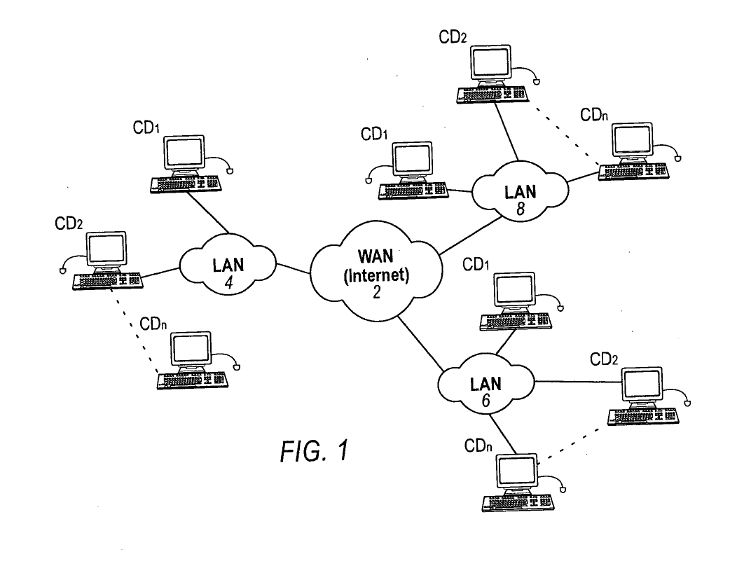

FIG. 1 is a block diagram illustrating a network 2 consistent with the conventional systems. The network 2 is a wide-area network (WAN) that interconnects a plurality of LANs 4, 6, and 8. Each LAN 4, 6, and 8 includes a plurality of communication devices CD₁-CDₙ. In each of the LANs 4, 6, and 8 the communication device CD₁ is a server and the remaining communication devices CD₂-CDₙ are clients.

Each of the communication devices CD₁-CDₙ and computer systems in general, have an infrastructure that includes a number of interdependent layers. The interdependent layers of the infrastructure are arranged based on increasing levels of abstraction or complexity. These layers communicate with each other to control various functions of the respective device. Moreover, each layer builds on the facilities of the underlying layer. While there may be any number of layers in the infrastructure of a single communication device, every computer connected to a network has a commonality of three layers. That is, each computer has a central processor (CPU) that processes all data, an operating system that interacts with the CPU, and applications that interact with the operating system to provide an interface to the user. While some special purpose systems, such as a router, may seem to fuse layers, the individual components are still present and discernable.

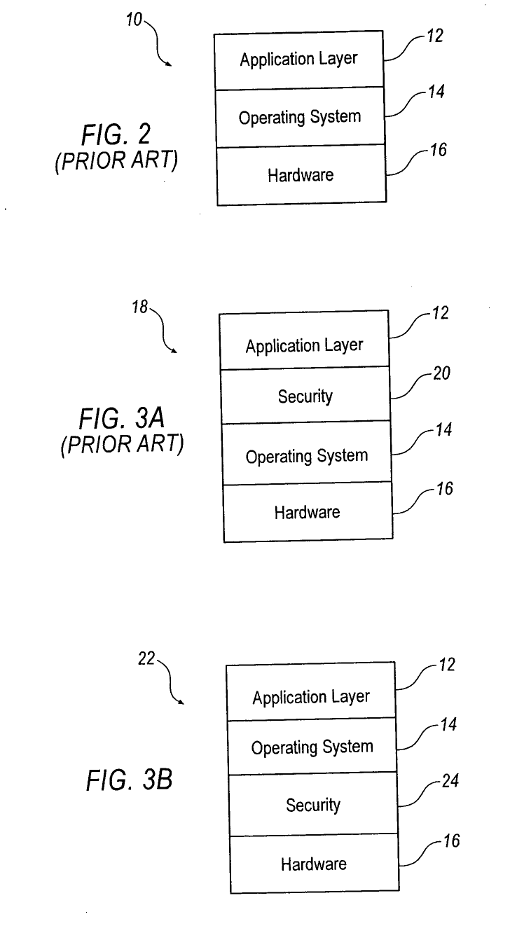

FIG. 2 is a block diagram illustrating a common logical infrastructure 10 of a computer in accordance with conventional systems. As shown in FIG. 2, for example, regardless of whether a computer is a stand-alone device, a server, or a client, all computers share the common logical infrastructure 10. The common logical infrastructure 10 includes an application layer 12, an operating system layer 14, and a hardware layer 16.

The application layer 12 is generally the most complex layer in the infrastructure of a computer. The application layer 12 includes high-level application software that interfaces with a user so that the user can complete a specified task. The application layer translates the actions of the user into a data format that can be understood by the operating system layer 14.

The operating system layer 14 includes an operating system. The operating system includes a plurality of modules collectively called the kernel. The plurality of modules that make up the kernel perform a variety of functions and may include, for example, a process management module, a file management module, a networking module, a memory management module, an Input/Output System Management module, and a Device Drivers module. The operating system layer 14 routes data flows received from the application layer 12 through the kernel so that the data flowing from a software application of the application layer 12 is translated into a format that can be understood by components of the hardware layer 16.

In essence, the operating system is a flow router that directs data to a software application of the application layer 12, directs data around the kernel, and directs data to the components of the hardware layer 16. In a complete cycle, the operating system:
1. Receives data from software applications of the application layer 12;
2. Translates the received data through the appropriate kernel modules of the operating system layer 14;
3. Sends the transferred data to a CPU of the hardware layer 16;
4. Receives processed data from the CPU of the hardware layer 16;
5. Translates the received data through the appropriate kernel modules of the operating system layer 14; and
6. Sends the translated data to the software application of the application layer 12.

The hardware layer 16 is generally the most abstract layer in the common logical infrastructure 10. The hardware layer 16 may include, for example, transistors, wires, logic gates, the CPU, and memory devices. The components of the hardware layer 16 work collectively to generate signals and process information. The CPU, for example, may pass information between itself and the operating system of operating system layer 14. In the alternative, the CPU may pass information between itself and other hardware components, such as a keyboard, a display, a mouse, a printer, a peripheral memory device, a modem, a network chip, or the like. All functions performed by the components of the hardware layer 16, and particularly those functions performed by CPU, are based on an instruction received from the operating system of the operating system layer 14. CPU data based on the information received from a software application of the application layer 12 via the operating system of the operating system layer 14.

FIG. 3a is a block diagram illustrating a secure logical infrastructure 18 consistent with conventional systems. The secure logical infrastructure 18 integrates a security layer 20 into the common logical infrastructure 10. The security layer 20 is placed at a level between the application layer 12 and the operating system layer 14. The security layer 20 may monitor and control all data flowing between a software application of application layer 12 and the operating system of operating system layer 14.

FIG. 3b is a block diagram illustrating a secure logical infrastructure 22 consistent with the present invention. The secure infrastructure 22 integrates a security layer 24 into the common logical infrastructure 10. The security layer 24 resides at a level between the operating system layer 14 and the hardware layer 16. By locating the security layer 24 below the operating system of the operating system layer 14, data flow can be controlled at the CPU of the hardware layer 16. The security layer 24 does not eliminate the vulnerabilities of the computer, however, because of the location of the security layer 24 within the infrastructure these vulnerabilities cannot be exploited. In particular, the vulnerabilities cannot be exploited because the security layer 24 denies unauthorized access to the memory space or the CPU of the hardware layer 16.

The security layer 24 is software based and includes a plurality of modules that perform various functions. The modules that are included in the security layer 24 are device specific and based on the CPU-operating system combination of the computer.

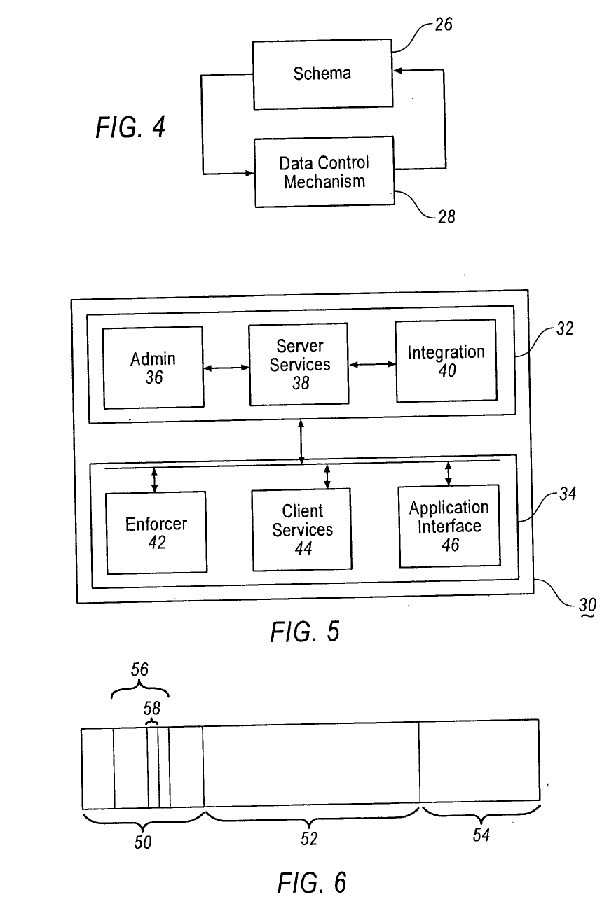

FIG. 4 is a block diagram illustrating an operational model of the secure logical infrastructure 22 consistent with the present invention. The effectiveness of the secure logical infrastructure 22 is based on a schema 26 and a data flow control mechanism 28 that are implemented through the security layer 24. The schema 26 provides the rules-based configuration and front-end infrastructure to secure all data flows on a computer and network, such as, the communication devices CD₁-CDₙ and the network 2. The schema 26 can be interpreted across various computer and network platforms. Moreover, the schema 26 can be updated as computer or network conditions change, or computer or network permissions change. The schema 26 is managed globally over the network 2 through the communication device CD₁-CDₙ that function as servers, for example, the server communication devices CD₁. The schema 26 is managed locally on the network 2 through the remaining communication devices CD₁-CDₙ that function as clients. The server communication devices CD₁, send a client-specific portion of the schema 26 to the client communication devices CD₂-CDₙ, so that this portion of the schema 26 may reside within each client communication device CD₂-CDₙ. The data flow control mechanism 28, which is described in detail below, is a hidden element that resides within the security layer 24. The data flow control mechanism 24 is an extension of the operating system of the operating system layer 14 and is installed in both the server communication devices CD₁, and the client communication devices CD₂-CDₙ. The data flow control mechanism 24 monitors data flow and determines whether the data flow conforms to the schema 26. The data flow control mechanism 24 can be implemented on various computer and system platforms. The resulting effect of the schema 26 and the data flow control mechanism 28 is a secure logical infrastructure 22 that provides true multi-level security, and allows data of various classifications to be processed simultaneously on the same computer system while maintaining absolute separation between the data of each classification.

FIG. 5 is a block diagram illustrating security domain components of a security domain 30 consistent with the present invention. The security domain 30 is established when the security infrastructure 22 is implemented within communication devices CD₁-CDₙ of the network 2. The security domain 30 includes a server package 32 and a client package 34. The server package 32 is implemented on, for example, a server communication device CD₁ and includes an admin module 36, a server services module 38, and an integration module 40. The client package 34 is implemented on, for example, a client communication device CD₂-CDₙ that includes an enforcer module 42, a client services module 44, and an application interface module 46.

The admin module 36 communicates with the server services module 38, stores the schema 26, and stores tools necessary to configure the security domain 30. The admin module 36 uses a graphical user interface (GUI) or web interface to graphically depict the schema 26, network objects, network configuration, and other information necessary to properly manage the security domain 30, as discussed in further detail below.

The server services module 38 receives the schema 26 and configuration data that establish the security domain 30 on the network from the admin module 36. The server services module 38 manages the schema 26 and the security infrastructure 22 of the security domain 30. In particular, the server services module 38 manages the schema 26 and secure infrastructure 22 by sending updates of the schema 26 to all affected client communication devices CD₂-CDₙ, and by responding to queries or requests generated by the client communication devices CD₂-CDₙ.

The integration module 40 communicates with the server services module 38, manages and operates security trusts, and performs legacy compliance. Security trusts and legal compliance include processes that place limitations on data access by computers located outside the LAN, for example, LANs 4, 5, 6 and within the security domain 30. The integration module 40 enables the server communication devices CD₁ to communicate with foreign communication devices (not shown). Foreign communication devices are those devices that are located outside of the security domain 30 of the network 2. Moreover, a computer is deemed a foreign communication device if it is located on the network 2 but does not include a secure logical infrastructure 22. The integration module 40 converts identification information associated with the server communication device CD₁, into identification information that can be recognized and understood by the foreign computer.

In the client package 34, the enforcer module 42 communicates with the client services module 44, and regulates the flow of data into and out of each of the client communication devices CD₂-CDₙ by enforcing the schema 26 implemented within the security domain 30. The enforcer module 42 communicates with the client services module 44 to resolve flow requests that are not cached in internal memory. Further, the enforcer module 42 provides the application interface module 46 with information so that a user may be notified when software applications attempt to violate the schema 26.

The client services module 44 communicates with the server services module 38 of the server package 32. The client services module 44 also manages the client specific schema stored on the respective client communication device CD₂-CDₙ, and associated with the security domain 30. Further, the client services module 44 resolves all queries or requests that are local to the client communication device CD₁-CDₙ. The client services module 44 receives all the schema 26 and configuration changes from the server services module 38 of the server package 32. Moreover, the client services module 44 sends high-level queries to the server services module 38 of the server package 32 for resolution.

The application interface module 46 communicates with the client services module 44 and the enforcer module 42. The application interface module 46 integrates all applications running on the network 2 into the security domain 30. The application interface module 46 displays the schema 26 of data flows that are being processed by an associated software program. The application interface module 46 enables a user on the client communication device CD₂-CDₙ to set parameters of the schema 26 for newly created data. Further, the application interface module 46 enables a user to interact with warnings and notices generated within the security domain 30, and shut down applications when directed to do so by the client services module 44.

The application interface module 46 may be any one of two types. First, the application interface module 46 may be a generic interface that completely wraps the interface of the application and manages the entire application as a single entity with a single label. In this manner, all data flowing from the application is treated as if it were part of a security label of the application, and all data flowing into the application is regulated by the schema 26 for data flowing into the security label of the application. Second, the application interface module 46 may be a tailored interface that is created on an application-by-application basis. The application interface module 46 interfaces into the selected application via its communication application program interface, i.e., COM API. In this manner, the controls of the security domain 30 are integrated into the selected application.

A security domain may be established on a computer that is not connected to a WAN, such as network 2, through a LAN 4, 6, or 8. A stand-alone package on such a computer would model and include the components of the client package 34. The functionality of the enforcer module 42, the client services module 44, and the application interface module 46 are kept intact, except for those functions that include communication with a server.

FIG. 6 is a block diagram illustrating a data format consistent with the present invention. The data and control information that is transmitted through a network can take a variety of formats. Common terms used to describe these formats include frames, packets, datagrams, segments, messages, cells, and data units. Each of the aforementioned formats may include a variety of components such as, a header 50, payload 52, and a trailer 54. Many software applications and particularly Internet based applications frequently include a meta-data component 56 within the header 50. The meta-data 56 describes how and when and by whom a particular set of data was collected, and how the data is formatted.

In classifying the data, all data objects and data files that flow through the security domain 30 are assigned a security level. This security level is associated with the data objects and data files through a security label 58 located in the header 50 or the meta-data component 56. The security label 58 designates the separation of data files within the security domain 30 between a plurality of information boundaries 60, which are used for data handling. Further, the security label 58 identifies the type of information that each data object is authorized to process.

The meta-data component 56 of each data object and data file within the security domain 30 are functional control labels that identify the file-controlled functions performed by the schema 26 and/or user settings. The file stream controls of the meta-data component 56 are effective through an abstraction to the existing file system of the operating system of the operating system layer 14. These file stream controls are inserted into the existing file system of the operating system as a file extension. The file extension and meta-data scheme provide the basis for all data storage on the network 2 while maintaining the information boundaries established by the security label 58 of each data object and data file.

Within the security domain 30, each element in the data format is parsed out and identified so that the data flow can be securely controlled. However, users within the security domain 30 only have access to that portion of the data to which they are authorized. Moreover, when data having a meta-data component 56 and security label 58 is resident on a foreign computer located outside of the security domain 30, the foreign computer cannot see nor parse the various components of the data. In particular, the foreign computer sees the data components as a jumbled mess.

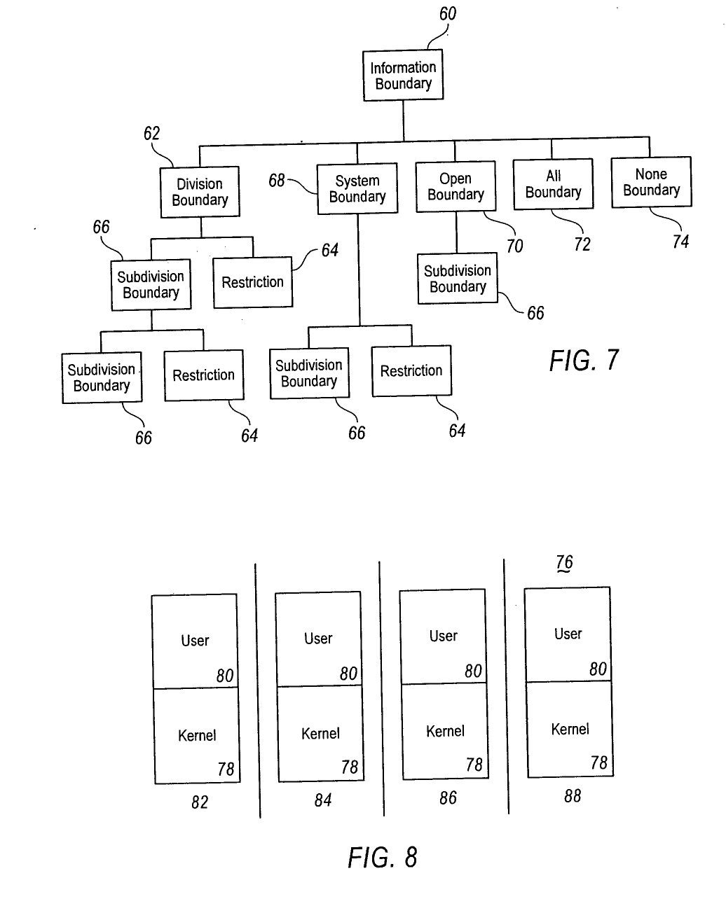

FIG. 7 is a block diagram illustrating the information boundary 60 consistent with the present invention. As discussed above, the security label 58 associated with each data object and data file designates the information boundary 60 within which the respective data object or data file resides. The information boundary 60 is an abstract data type used as a template for three types of specific information boundaries. In particular, the information boundary 60 includes a division boundary 62, a restriction boundary 64, and a subdivision boundary 66. Moreover, other division-type boundaries included in the information boundary 60 include a system division boundary 68, an open division boundary 70, an all division boundary 72, and a none division boundary 74. Among the division-type boundaries, the system division boundary 68, the open division boundary 70, the all division boundary 72, and the none division boundary 74 are all fixed boundaries. Each of these boundaries form an object oriented inheritance relationship with the abstract information boundary 60.

Through the configuration of the division-type boundaries 62, 68, 70, 72, 74 and the schema 26, data and systemic objects are granularly controlled to the extent that only those resources defined within a respective division-type boundary have access to the information within that boundary. For example, within the security domain 30 users and peripherals may be assigned a security label 58 that authorizes access to all data within the division boundary 62 named “Classified.” On the other hand, some of those same users and peripherals may be assigned a security label 58 that authorizes access to data categorized in the division boundary 62 named “Classified” and restricts them through the subdivision boundary 66 to a group of files under a “Project A” heading.

The division-type boundaries 62, 68, 70, 72, 74 may be configured with any number of labels or structures. In particular, the configuration of the division-type boundaries 62, 68, 70, 72, 74 may reflect every property and practice of a business model within a government or commercial entity. As a result of this configuration, the flow of information may reflect the business structure and strategy of that particular entity. Once an entity establishes a business structure or hierarchy through the division-type boundaries 62, 68, 70, 72, 74, users are integrated into the network 2 based on their position in the overall business model. In other words, users are added to a group that matches their position within the government or commercial entity. Accordingly, users acquire access to all information and resources needed to complete projects and fulfill their job requirements at their assigned level.

The restriction boundary 64 is a data tag that is used in conjunction with a root information boundary. The root information boundary may be any one of the three information boundary types. However, in order to apply the restriction boundary 64, the top-level information boundary must be a division boundary type. The security label 58 that results from data tagged using a restriction of the restriction boundary 64 has a ‘root+restriction’ format. A single restriction of the restriction boundary 64 may have many possible roots, but only one root can be used for a single instance of a data tag. However, any number of restrictions may be added to a root. When a ‘root+restriction’ label is applied to a data item, the user must have access to both the root and the restriction in order to access that data item.

The restriction boundary 64 may be used to apply various characteristics to the data item. For example, the restriction boundary 64 may indicate the number of times that the data file may be access before access to the file is restricted. The restriction boundary 64 may also indicate the mortality of the data item, i.e., a date and/or time after which further access to the file is restricted. Further, as it relates to email, the restriction boundary 64, may indicate whether the data item can be forwarded. Still further, the restriction boundary 64 may indicate whether the data item may be saved to a hard drive, a portable memory device, or an external memory device. The restriction boundary 64 may also indicate whether the data may be printed, or alternatively, the restriction boundary 64 may selectively indicate on which printers of the network that the data item may be printed. The aforementioned examples of applications of the restriction boundary 64 are not exhaustive. The applicability and uses of the restriction boundary 64 are endless and can affect the manner in which data items within the security domain 30 are accessed and how peripheral resources within the security domain 30 are used.

The subdivision boundary 66 may divide any of the aforementioned division-type boundaries 62, 68, 70, 72, 74, as well as, any other subdivision boundaries. The subdivision boundary 66 divides parent division boundaries or higher-level subdivision boundaries into a more narrowly scoped information boundary. As a result, the parent division boundary has full access to data within the child subdivision boundary, but a child subdivision does not have access to all data within the parent division boundary.

The system division boundary 68 is permanently hidden and can only be changed indirectly through re-configuring the schema 26. The system division boundary 68 provides the systemic protections necessary to ensure the integrity of the security domain 30 and ensure that all data is protected. The system division boundary 68 contains systems logs and protected operating system files, which are only accessible by the operating system of the operating system layer 14. The system division boundary 68 also includes configuration data necessary to boot-up the CPU of the respective computer so that the security domain 30 can be established. This configuration data includes the accreditation data of the respective computer, which indicates the information boundaries to which the computer may access the data flow. Furthermore, although the device drivers for applications and hardware devices are located in the operating system of the computer, the functional portion of the device drivers are located in the system division boundary 68. In this manner, the security domain 30 establishes control over all of the input/output devices connected to a computer, such as each communication device CD₁-CDₙ on the network 2.

The open division boundary 70 maintains the secure integrity of data as long as that data remains within the security domain 30. The data contained within the open division boundary 70 is allowed to pass outside of the security domain 30. In this manner, the open division boundary 70 provides the capability to interface with the Internet and other systems that do not have a compatible secure infrastructure 22.

The all division boundary 72 is a data tag that may be applied to data objects so that access to those data objects is granted across all information boundaries 60. For example, a printer within the security domain 30 may be configured to print any level of available information. Moreover, an officer of a corporation may have an all tag assigned to his or her account so that data across all divisions of the company may be accessed.

The none division boundary 74 is a data tag that may be applied to data objects so that those data objects cannot be accessed from any information boundary 60. In other words, the none division boundary 74 has a function that is opposite the function of the all division boundary 72.

By establishing information boundaries 60 on the network 2, the security domain 30 modifies the manner in which the memory on the network 2 and within each communication device CD₁-CDₙ is managed.

FIG. 8 is a block diagram illustrating an example of a memory management scheme consistent with the present invention. A memory space 76 is divided into an operating system (kernel) space 78 and an application (user) space 80. Further, the information boundary includes a Top Secret Division 82, a Secret Division 84, a Classified Division 86, and a System Division 88. Thus, each division of the information boundary includes a kernel space 78 and a user space 80. In conventional systems, the operating system sends information to the CPU on how the memory space should be divided, and more particularly to identify the memory space that should be allocated to a particular software application. However, in the present invention the CPU ignores the commands of the operating system and instead only executes processes based on those commands received via the kernel space 78 of the System Division boundary 88. The kernel space 78 in the System Division boundary 88 instructs the CPU to allocate memory space to a user process based on a local page table. The kernel space 78 copies the allocated local page table to a global page table maintained within the System Division boundary 88. The CPU is then commanded to divide the local page tables for each application into multiple page tables based on the security labels 58. Each memory page may contain only one security label 58 of information.

The memory management scheme of the present invention provides true object reuse. Furthermore, because this memory management scheme is based on security labels 58 and is not subject to the privilege memory separation operation performed by the operating system, the vulnerabilities of the conventional memory management techniques are resolved. For example, under this secure memory management model the CPU may operate at any privilege level and a thread of a software application will not get access to data that it is not authorized to view. Further, because of the security label 58, the secure memory management model of the current invention renders ineffective any instruction that attempts to change the privilege level of the CPU or access an area of memory that is not authorized at the current privilege level of the CPU. Still further, under the constructs of the secure memory management model rogue software applications are not a threat to other programs because any instruction that these rogue applications execute must include a security label 58 and conform to the related schema 26. Thus, secure data is always protected.

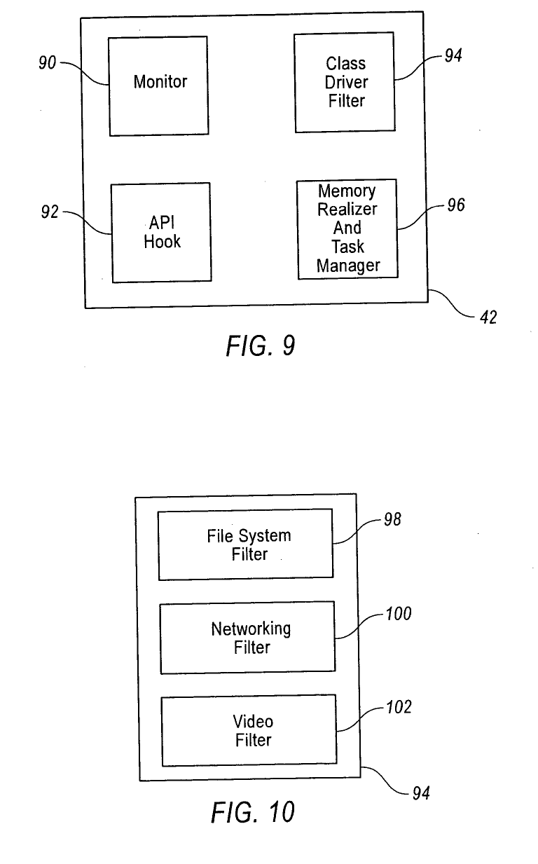

FIG. 9 is a block diagram illustrating the components of the enforcer module 42 in accordance with the present invention. The secure memory management model discussed above is implemented through the adaptation of the enforcer module 42 to the specific computer or network platform. The enforcer module 42 is a collection of device drivers that translate into kernel extensions for the operating system of the operating system layer 14 and its interaction with the hardware of the hardware layer 16. The enforcer module 42 corresponds to the data flow control mechanism 28 shown in FIG. 4, and implements the memory management model as described above. The configuration of the enforcer module 42 is unique for every CPU-operating system (OS) combination. Though the functionality for achieving true flow control is consistent across all platforms, each individual platform requires an enforcer module 42 that is compatible with that platform. Therefore, even if the communication devices CD₁-CDₙ of the network 2 are of varying platforms, true flow control is still achieved when the enforcer module 42 of each the communication devices CD₁-CDₙ is configured based on the platform of that particular device.

The enforcer module 42 interjects transparent, add-on functions into the operating system of the computer. These add-on functions conform to prototypes and specifications of the original functions so that the functions of the security layer 24 are transparent to the operating system of the operating system layer 14. These add-on functions, however, enable the enforcer module 42 to monitor data, thereby ensuring that the requested data flow conforms to the schema 26. If the enforcer module 42 determines that the requested data flow fails to conform to the schema 26, then the associated function creates an error that is consistent with the existing published error conditions established for the function by the operating system of the computer. As a result, a user recognizes no difference between an operational message displayed by a computer having a common logical infrastructure 10 and an operational message displayed by a computer having the secure logical infrastructure 22.

As shown in FIG. 9, the enforcer module 42 includes a monitor 90, an Application Program Interface (API) Hook 92, a class driver filter 94, and a memory realizer and task manager 96.

The monitor 90 maintains the integrity of the enforcer module 42 by performing health and status checks. The monitor 90 follows a checklist to perform the health and status checks. This checklist includes various aspects of the enforcer module 42 that should be checked, such as, components of the API Hook 92, the class driver filter 94, and the memory realizer and task manager 96.

The API Hook component 92 provides flow control functionality to the operating system and protects the operating system against tampering by ensuring that additional elements such as programs, applications, or devices that are added to the operating system work with the security domain 30. Moreover, the API Hooks component 92 maintains data encryption making the security domain 30 non-circumventable by ensuring that no third-party interface may control data access.

The class driver filter 94 assigns and implements one filter for each input/output device configured on the computer.

The memory realizer and task manager 96 decrypts data transferred from protected memory data by the page handler and transfers the decrypted data into CPU cache. Further, when memory is allocated from areas of memory that contain files having a common attribute, for example, the memory realizer and task manager 96 adds the decrypted data to the page table of the security label associated with the thread that allocated the memory. The memory realizer and task manager 96 manages shared memory similar to the manner in which a file is managed. When first created, the memory realizer and task manager component 96 assigns the shared memory a security label corresponding to the least privileged process having access to it. Generally, these processes will be identical, but if they are not, the “higher” process maps the shared memory as “copy on write.” This means that if the “higher” process writes higher data to the file, the “higher” process makes a copy of the shared memory, and then strictly accesses that copy. The activity of the “higher” process is transparent to the “lower” process as the “lower” process maintains access to the shared memory of the original version. However, the user is notified of the activity of the “higher” process. Then if authorized by the security administrator, the user may then reestablish the shared memory connection by raising the “lower” threads security level.

FIG. 10 is a block diagram illustrating components of the class driver filter 94 consistent with the present invention. The class driver filter 94 includes a file system filter 98, a networking filter 100, and a video filter 102.

The file system filter 98 ensures that the entire storage disk of the communication device CD₁-CDₙ is encrypted. With the exception of kernal files of the system division boundary 68 that are used by the operating system to boot the respective communication device CD₁-CDₙ and establish the security domain 30, the file system filter 98 encrypts data stored to an external memory device and data that is retrieved into memory. Moreover, the file system filter 98 will only return or display files that a user is authorized to access such that the user is unaware that files the user is not authorized to access even exist. As a result of the encryption, the file system filter 98 prevents protected files from recovery outside of the security domain 30. In addition, because extra meta-data 56 is stored in the header 50 of the data file, the security label 58 is always attached to the data.

The networking filter 100 ensures that data at the Transmission Control Protocol (TCP) level and the Open System Interconnection (OSI) level are encrypted so that all data communicated over the network 2 is protected. In addition, the networking filter 100 ensures that the Internet Protocol (IP) of network 2 is also encrypted. The networking filter 100 ensures that data is encrypted by integrating the integrity checks performed by the encryption process into the TCP/IP redress process. Further, the networking filter 100 performs an additional check to ensure that the destination device (any one of the communication devices CD₁-CDₙ) is authorized to receive the data being sent. If the destination device is not authorized to receive the data being sent, then the originating device (any one of the communication devices CD₁-CDₙ different from the destination device) will be notified that the transmission was canceled.

The video filter 102 is an input only filter that allows all data flowing into a video driver of the device to be carried out directly. In this manner, fast video operation is available for graphic intensive programs. The video filter 102 functionality is only available if the communication device CD₁-CDₙ that attempts to read video data is at a session level in which the entire screen can be read. Moreover, a thread of a software application may only read the contents of its own window via the APIs. The video filter 102 only allows direct reading of the video data when the session level is in an ‘Open’ state.

The input device filters of the class driver filter 94 labels all raw input data according to the security-handling requirement. The data is then handed off to the operating system for input processing. The operating system of communication device CD₁-CDₙ then places the data in a message queue that is associated with the proper thread of the software application. Next, the data is then associated with the security level of that thread. The other devices are treated generically in terms of the security domain 30. All inbound raw data is encrypted and all outgoing data remains encrypted and is transmitted within the bounds of the security domain 30 based on the security label 58. The device drivers of the system division boundary 68 are the elements that modify the information flow control beyond the internal CPU/memory to all the computing devices and across the network.

The monitor 90 controls the process of adding new device drivers in the same manner as hooking a function of a software application, as described above. Because the system package 32 of the security domain 30 controls the security of all external input/output devices, the system package 32 ensures that the device drivers needed to operate input/output devices are internal to the security domain drive filters of the network, and all other filters are external to the security domain 30. In this manner, the input/output equipment will work properly and all information flows through the security domain drive filters before further processing is performed. Therefore, when a new device driver is added to the class driver filter 94, the monitor 90 notifies the server services module 38 of the server package 32, so that the schema 26 and configuration information of the secure domain 30 may be updated.

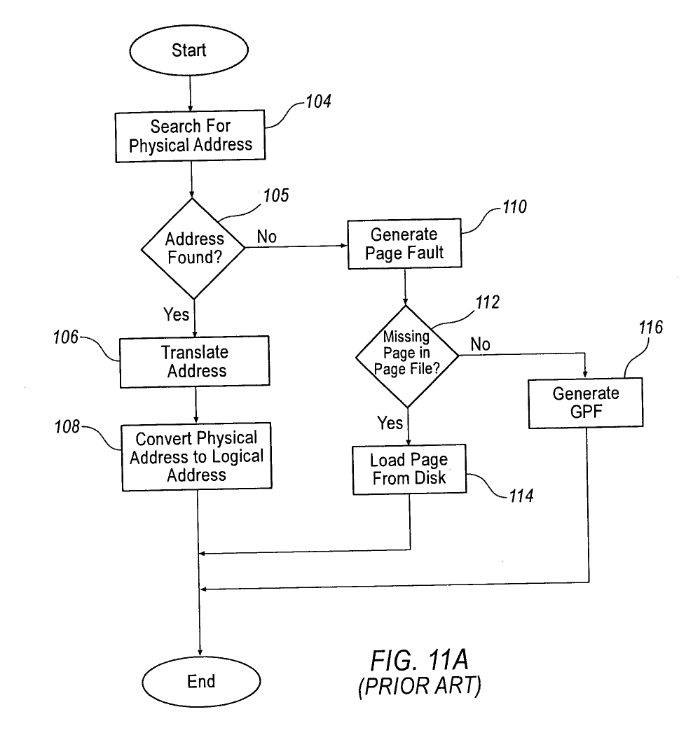

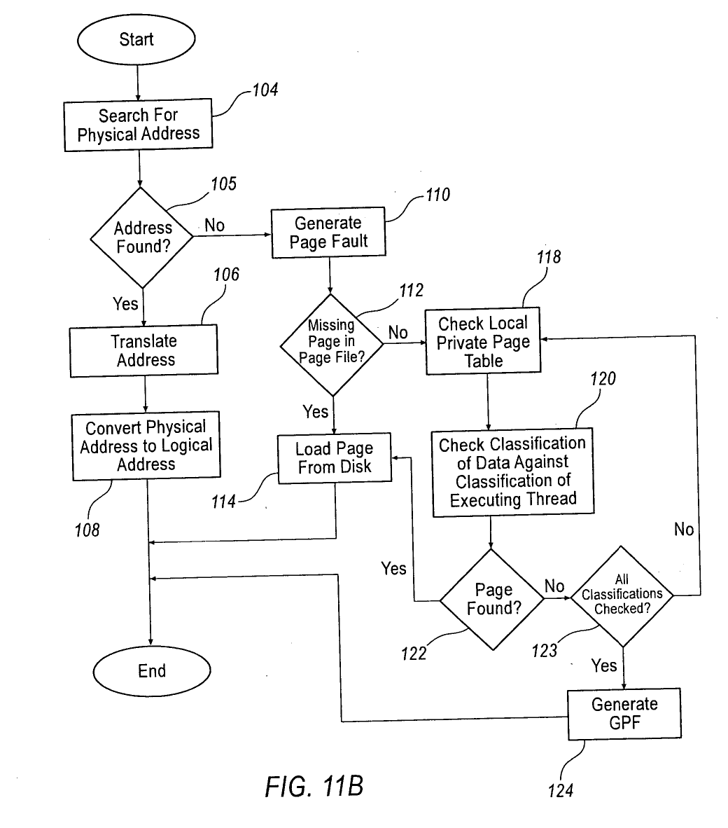

FIG. 11a is a flow diagram illustrating an example of a memory management process consistent with a conventional computer system. The CPU first attempts to translate the address to its physical equivalent by looking up either the global descriptor table (GDT) or local descriptor table (LDT)—depending whether the address is in the kernel or user address space range (Step 104). The tables pointed to by the GDT and LDT registers equate to the entire page tables for the operating system and user process. Next, the CPU determines whether the address was found (Step 105). If the appropriate page is found, the corresponding address is converted into the physical address (Step 106). Next, at step 108, the CPU replaces the physical address with the logical address so that the instruction can be executed. If the page is not found, the operating system instructs the CPU to generate a page fault, and execution is handed off to a known resolver function (Step 110). The operating system then determines if the missing page is located in the page file (Step 112). If the missing page is determined to be located in the page file, the page handler loads the page from the disk and completes the transaction as if the page were initially in RAM (Step 114). If the page is not found in the page file, a General Protection Fault (GPF) error is invoked (Step 116).

FIG. 11b is a flow diagram illustrating an example of a memory management process consistent with the present invention. When the security infrastructure 18 is implemented on the communication device CD₁-CDₙ running the same operating system as in FIG. 11a, Steps 104 through 1 14 are performed as described above, however, the memory management process of the present invention includes additional steps are added. For example, when a page is not found in the page file (Step 112), the memory realizer and task manager 96 checks a local private page table used to store the classified data (Step 118). The memory realizer and task manager 96 checks a first classification that matches the classification of the executing thread, by first checking the random access memory (RAM) and then the page file (Step 120). Next, the memory realizer and task manager 96 determines whether the page has been found (Step 122). If the page still is not found, the memory realizer and task manager 96 repeats the above process until all flowable classifications to the thread classification are checked (Step 123). If the memory realizer and task manager 96 still has not found the memory address, at a step 124, the GPF error is generated (Step 124).

As mentioned earlier, the operating system on the communication devices CD₁-CDₙ may include multiple protected page files. If the selected page table is different from the current security level of the executing thread, the memory realizer and task manager component 96 manages the memory similarly to the manner in which shared memory is managed. That is, the memory realizer and task manager 96 marks the page as “copy on write,” and the executing hread may read the page without any restrictions. However, if the thread attempts to write to the page, the memory realizer and task manager 96 copies the page and assigns the page the same security label as the security label of the thread. The new page becomes the new resolution for referencing the executing thread to the memory location.

In support of the virtual memory manager residing on the operating system, the memory realizer and task manager 96 clears the CPU cache to ensure that data from the current task is not accessible when the next task is executed. The memory realizer and task manager 96 ensures that each thread does not exceed the security level of the process in which it operates.

To achieve total file control, the memory realizer and task manager 96 generates individual meta-data control labels and associates these labels with inserted data file extensions. The individual meta-data control labels are functional rather than literal and are depicted to identify the file-controlled functions performed by the schema 26 or user settings. In this manner, the foundation of the security model is established.

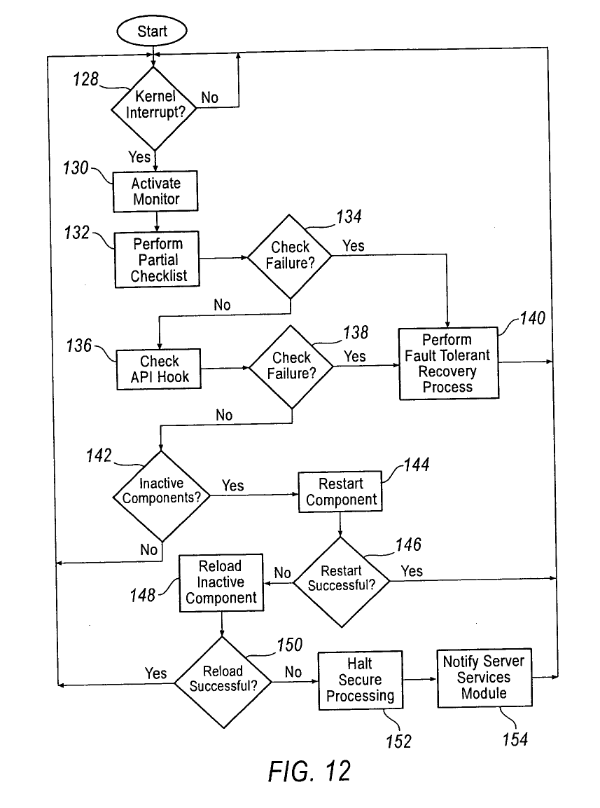

FIG. 12 is a flow diagram illustrating a health and status check process consistent with the present invention. The monitor 90 determines whether a kernel interrupt has been received from the operating system (Step 128). When the operating system issues a kernel interrupt, the monitor 90 is activated (Step 130). Following activation, the monitor 90 executes a system check based on a portion of the checklist for a predetermined slice of time (Step 132). In executing the partial checklist, the monitor 90 first performs a secure hash of all other components of the enforcer module 42 that are currently operating and compares the result to a predetermined digitally signed hash value. The monitor 90 then determines whether any checks are performed based on the partial checklist fail (Step 134). If no checks fail, the monitor 90 then checks the API Hook 92 to ensure that each API and interrupt hook is still wrapped at the appropriate point by the secure infrastructure 22 (Step 136). Next, the monitor 90 determines whether any of these checks fail (Step 138). If the any of the checks performed based on the partial checklist or the API Hook 92 fail, the monitor 90 performs any of the known fault tolerant recovery processes (Step 140). On the other hand, if none of the API and interrupt hook checks fail then monitor 90 determines whether any components of the enforcer module 42 are inactive (Step 142). If the monitor 90 determines that no components are inactive then the health and status check is complete and the monitor 90 returns to the inactive state and awaits receipt of another interrupt. However, if the monitor 90 determines that a component is inactive, then the monitor 90 attempts to restart the inactive component (Step 144). If attempts to restart the inactive component are successful, the health and status check is complete and the monitor 90 returns to the inactive state and awaits receipt of another interrupt (Step 146). If attempts to restart the inactive component are unsuccessful, the inactive component is deemed corrupted, and the monitor 90 then attempts to reload the inactive component (Step 148). If the monitor 90 fails to both restart the inactive component and reload the inactive component, at a step 150, the enforcer module 42 of the client 30 halts all secure processing and notifies the server services module 38 of the server package 32 (Steps 152 and 154), in accordance with the schema 26. On the other hand, if the monitor 90 successfully reloads the inactive component the health and status check is complete and the monitor 90 returns to the inactive state and awaits receipt of another interrupt.

When the API Hook 92 hooks a function of a software application a corresponding element is added to the server services module 38 of client communication devices CD₁ so that the schema 26 and configuration of the security domain 30 can be updated, if necessary. Further, by adding a corresponding element to the server services module 38, application functions will continue to use recognized and published return values, which means that user programs will not produce any unexpected behavior, thereby maintaining the stability of the application. The additional API functions that are hooked also provide the capability for future hooking. As long as the API Hook 92 stores the additional hooks, the additional hooks do not circumvent the functions of the security layer 24. The monitor 90 ensures that all hooks pass through the functions of the security layer 24. Further, the monitor 90 does not attempt to replace the hooks.

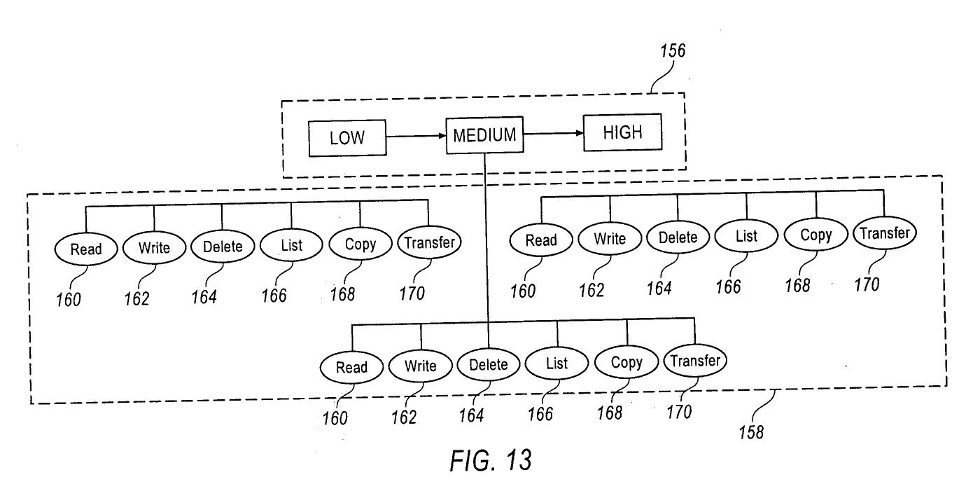

FIG. 13 is a block diagram illustrating a security model consistent with the present invention. The security model of the security domain 30 includes a Mandatory Access Control (MAC) level 156 and a Discretionary Access Control (DAC) level 158.

The MAC level 156 is an expanded implementation of a Bell-LaPadula type system, where all objects and data on the system have a security level associated with them and the objects and data are identified by means of this label noted in the meta-data 56. For example, to access data an authorized user must have an access level that matches the security criteria of the data. In the event the user does not meet preceding criteria, then all access is denied and the data is transparent to the user such that the user is unaware of the existence of the data. On a network with three classifications of data: ‘Low’, ‘Medium’ and ‘High’, a user with ‘Medium’ authority can see ‘Medium’ and ‘Low’ data. However, the user will have no indication ‘High’ data exists anywhere on the network. A directory listing initiated by the user would only display the existence of ‘Low’ and ‘Medium’ files, excluding all ‘High’ files. On the other hand, if a user with ‘High’ authority logged onto the same network, and listed the same directory, it would display all of the ‘High’, ‘Medium’ and ‘Low’ data files. Once the enforcer 42 determines that a user is authorized to access a file, the permissions associated with the user are checked to determine what actions the user is authorized to perform with the data.

The DAC level 158 is the second level of the security model and includes five permissions, which are generally associated with directory protection. These five permissions are, for example, a read permission 160, a write permission 162, a delete permission 164, a list permission 166, a copy permission 168, and a transfer permission 170.

The read permission 160 corresponds to a user having the capability to read the contents of a data file or run an executable file. The Write permission 162 enables the user to create raw data up to the logged on security level. The delete permission 164 enables the user to permanently erase files within the security domain 30. The List permission 166 is a special purpose permission used primarily by the system to view the existence of all data, but not the ability to view that data. The List permission 166 is used by backup utilities in order to safely backup data, yet keep the contents of the data protected. The Copy permission 168 identifies the number of copies allowed of the file and its mortality beyond the original copy. The Transfer 170 permission allows the user to reduce data from a higher security level to a lower security level against all established information flow configurations.

The security domain 30 uses a modular design encryption implementation strategy. This strategy provides flexibility and is aimed at supporting an organization that has a preferred or approved encryption scheme, thus allowing the security domain infrastructure to be “plugged in”.

The default method of data encryption uses the symmetric Advanced Encryption Standard (AES) but any module of data encryption can be used. Moreover, each file within the security domain 30 will retain its private encryption key within the embedded meta-data. Once the user attempts to access a stored file, a client-unique master key is used by the system to extract the private file key. This key goes through a systemic authentication check and then unencrypts the file for user access.

The security domain 30 does not require path modification for transporting data over the network, but uses path in its original state. In view of the existing encryption, all data is sufficiently protected. Moreover, additional protection between trusted security domains and users may be achieved by further encapsulating each data packet by using a communal VPN-like engine at the point where the Internet is used as the communications path.

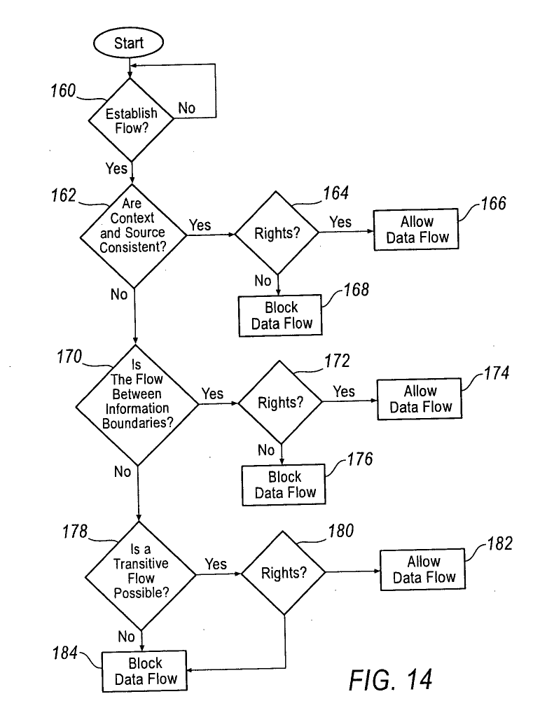

FIG. 14 is a flow diagram illustrating the establishment of data flow consistent with the present invention.

On a computer located within an established secure domain 30, a user attempts to establish a data flow on a computer which can include a number of different operations, for example, opening a file associated with a software application, attach a file to an email, open a file attached to an email, start a software application, or the like (Step 160). Next, the enforcer 42 determines whether the context of the data is consistent with the source of the data (Step 162). The context of the data is determined by the security label 58 attached to the data. Step 162 ensures that the manner in which the user wants to use the data, for example, printing, emailing, deleting, or the like, matches the context of the data. If the context of the data is consistent with the source of the data then the enforcer determines whether the user attempting to access the file is authorized to access the file (Step 164). Here the enforcer 42 identifies where within the information boundary the data is located and whether the user has access to data within that boundary based on applicable divisions, sub-divisions, or restrictions. If the user is authorized to access the data, then the enforcer 42 allows the flow to be established (Step 166). On the other hand, if the user is not authorized to access the data then the enforcer 42 prevents establishment of the data flow (Step 168).

If the enforcer 42 determines that the context of the data and the source of the data are not consistent, the enforcer then determines whether the data flow is being sent across information boundaries (Step 170). In particular, the enforcer 42 determines whether the data flow is traveling, for example, from a Classified division boundary to a Secret division boundary. If the data flow is going across information boundaries then the enforcer 42 determines whether the user is authorized to send data across information boundaries (Step 172). If the user is authorized to send the data across information boundaries, then the enforcer 42 allows the flow to be established (Step 174). On the other hand, if the user is not authorized to send the data across information boundaries then the enforcer 42 prevents establishment of the data flow (Step 176).

If the data is not being sent across information boundaries then the enforcer 42 determines whether transitive flows that include the data are possible (Step 178). In Step 178, the enforcer 42 examines the relationship between the user who originated the data flow and the user who receives or is attempting to access the data flow. If the enforcer 42 determines that transitive data flows are possible, then the enforcer 42 determines whether the user who originated the data flow is authorized to send that data flow to the receiving user (Step 180). If the originating user is authorized to send the data to the receiving user then the enforcer 42 allows the flow to be established (Step 182). On the other hand, if the originating user is not authorized to send the data to the receiving user then the enforcer 42 prevents establishment of the data flow (Step 184). Still further, if a transitive flow including the data is not allowed then the enforcer 42 prevents establishment of the data flow (Step 184).

The following examples illustrate the various capabilities of the secure infrastructure of the present invention.

A company has a corporate structure that includes an Officer level, Associate level, and a Staff level. The Officer level is the highest level in the corporate structure, and is followed by the Associate level. Accordingly, the Staff level is the lowest level in the corporate structure. The computer network of the company is established with a security domain having an officer level boundary, an associate level boundary, and a staff level boundary. User 1 is a corporate officer and logs into the network on a computer accredited to access files across all corporate levels. User 2 is a corporate associate and logs into the network on a computer accredited to access files at across all corporate levels.

### EXAMPLE 1

User 1 creates a document on the computer and assigns the document an officer level security label. User 1 prepares an email listing other corporate officers as recipients and inadvertently lists User 2 as a recipient. User 1 sends the email not realizing the mistake.

The computer of User 2 receives the email. The secure infrastructure within the computer of User 2, and particularly, the enforcer within the secure infrastructure of the computer of User 2 processes the email. When processing the email the enforcer first performs a check to determine whether the destination computer is authorized to receive the email. In this instance, because the computer of User 2 is accredited to access files across all corporate levels, the email passes this check. Next, the enforcer determines whether the user is authorized to receive the email. As noted above, User 2 is a corporate associate and is authorized to access data having a security label at the associate level and below. Because the email is labeled at an officer level, User 2 never receives the email. Namely, the email is stored in network memory space assigned to User 2, and User 2 has no knowledge that the email was sent. If, however, User 2 is promoted or is otherwise authorized to access officer level data, the email may later appear in User 2's inbox as a received email.

### EXAMPLE 2

The computer of User 1 receives an email from a computer outside of the security domain of the corporation. The received email has an attachment that contains a virus. Unknowingly, User 1 executes the attachment. Upon execution, the virus attempts to access the memory space of an associated application and modify or create a data flow. However, because the attachment contains data that has no associated security label, the enforcer will not allow any data to flow to or from the attachment. As a result, the execution of the attachment will fail and return a known error message that corresponds to the reason for its failure.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of managing data flow on a computer, comprising the steps of:
establishing a secure domain on the computer;
assigning a security label to data within the secure domain;
establishing a set of schema based on the security labels associated with the data; and
regulating data flow within the secure domain based on the set of schema.

2. The method of claim 1, wherein regulating data flow comprises the steps of:
determining whether a data flow conforms to the schema; and
processing the data flow when the data flow conforms to the schema.

3. The method of claim 1, wherein regulating the data flow comprises the steps of:
determining whether a data flow conforms to the schema; and
returning a known published message when the data flow fails to conform to the schema.

4. The method of claim 1, further comprising the step of:
managing the set of schema through a graphical user interface.

5. The method of claim 1, wherein assigning the security label establishes an information boundary, the method further comprising the step of:
dividing the information boundary into at least two division boundaries based on the security label of the data.

6. The method of claim 5, further comprising the step of:
dividing at least one of the division boundaries into at least two sub-division boundaries based on the security label of the data.

7. The method of claim 5, further comprising the step of:
setting a restriction boundary to the data within at least one of the division boundaries based on the security label of the data.

8. The method of claim 6, further comprising the step of:
setting a restriction boundary to the data within at least one of the sub-division boundaries.

9. The method of claim 1, wherein assigning the security label establishes an information boundary, the method further comprising the step of:
dividing the information boundary into at least two division-type boundaries based on the security label of the data.

10. The method of claim 1, further comprising the step of:
creating new data; and
setting parameters of a security label associated with the new data.

11. A method of managing data flow between a plurality of communication devices on a network, the method comprising the steps of:
in a first device of the plurality of communication devices:
establishing a secure domain on the network;
assigning a security label to data within the secure domain;
establishing a set of schema based on the security label of the data; and
regulating data flow within the secure domain based on the schema.

12. The method of claim 11, further comprising the steps of:
in the first device:
updating the set of schema through a graphical user interface; and
sending the updated schema to at least a second device of the plurality of communication devices in the secure domain of the network.

13. The method of claim 11, further comprising the steps of:
in the first device:
receiving a message from at least the second device; and
sending a response to the second device based on the received message.

14. The method of claim 11, further comprising the step of:
in the first device:
sending a message to a foreign communication device, wherein the foreign communication device is located outside the secure domain of the network.

15. The method of claim 11, further comprising the steps of:
in the first device:
creating new data; and
setting parameters of a security label associated with the new data.

16. The method of claim 15, further comprising the steps of:
in the first device:
updating the set of schema based on the security label of the new data; and
sending the updated schema to at least a second device of the plurality of communication devices in the secure domain of the network.

17. A method of managing data flow between a plurality of communication devices in a network having a secure domain, the method comprising:
in a first device of the plurality of communication devices:
receiving a data flow from a second device of the plurality of communication devices on the network;
determining whether the received data conforms to a set of schema associated with the secure domain; and
processing the received data flow when the data conforms to the set of schema.

18. The method of claim 17, further comprising the step of:
in the first communication device:
receiving the set of schema from a third device of the plurality of communication devices on the network.

19. The method of claim 18, further comprising the step of:
in the first communication device:
sending a message to the third device.

20. The method of claim 17, further comprising the steps of:
in the first communication device:
creating new data; and
setting parameters of a security label associated with the new data.

21. The method of claim 20, further comprising the steps of:
in the first communication device:
sending a message to the second device based on the new data and the security label.

22. The method of claim 21, further comprising the steps of:
in the first communication device:
receiving an updated set of schema based on the new data and security label.

23. A method of managing data flow between a plurality of communication devices in a network having a secure domain, the method comprising:
in a first device of the plurality of communication devices:
receiving a data flow from a second device of the plurality of communication devices on the network;
determining whether the received data flow conforms to a set of schema associated with the secure domain; and
displaying a known published message when the received data flow fails to conform to the set of schema.

24. A communication device that controls data flows on a network having a secure domain, the communication device comprising:
an administration module that provides a graphical user interface to designate a set of schema to correspond to data flow within the secure domain; and
a management module that determines whether data flows conform to the set of schema.

25. The communication device of claim 24, further comprising:
a service module that stores the set of schema and manages messages associated with the set of schema.

26. The communication device of claim 24, further comprising:
an interface module that synthesizes the set of schema with software installed on the communication device and displays classification information associated data included in the flow of data.

27. The communication device of claim 24, wherein the administration module and the management module are included in a secure layer located between an operating system layer and a hardware layer of a logical infrastructure of the communication device.

28. A method of establishing a data flow of data on a communication device in a secure domain, the method comprising the steps of:
comparing a context of the data to a source of the data;
determining whether a direction of the data flow, when the data context does not match the data source;
determining whether a transitive flow is authorized with the data, when the direction of the data flow is within a first information boundary;
determining whether a user is authorized to execute the data flow; and
establishing the data flow when the user is authorized to execute the data flow.

29. The method of claim 28, wherein the step of determining whether a user is authorized to execute the data flow is performed when the transitive flow is authorized.

30. The method of claim 28, wherein the step of determining whether a user is authorized to execute the data flow is performed when the data flow is from a first information boundary to a second information boundary.
